(19) United States
(12) Patent Application Publication
(10) Pub. No.: US 2009/0319576 A1
(43) Pub. Date: Dec. 24, 2009

(54) EXTENSIBLE TASK EXECUTION TECHNIQUES FOR NETWORK MANAGEMENT

(75) Inventors: Benjamin Srour, Seattle, WA (US); Ashvin Sanghvi, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,820

(22) Filed: Jun. 20, 2008

(51) Int. Cl. G06F 9/46; G06F 17/30

(52) U.S. Cl. 707/200; 718/100; 707/E17.005

(57) ABSTRACT

An extensible task execution technique includes receiving a stimulus, matching the stimulus to a given workflow instance, determining parameters applicable to the received stimulus and the given workflow instance, and executing one or more tasks on one or more target devices specified by the given workflow instance and the parameters.

### BACKGROUND

Computing systems have made significant contributions toward the advancement of modern society and are utilized in a number of applications to achieve advantageous results. Numerous devices, such as personal computers (PCs), laptop computers, personal digital assistants (PDAs), smart phones, servers, and the like have facilitated increased productivity and reduced costs in communicating and analyzing data in most areas of entertainment, education, business, and science. One common aspect of large computing systems is network administration. Network administration may include the deployment, configuration, maintenance, and monitoring of network equipment.

Typically, network administration is a labor intensive function. In the past users would send a message to the information technology (IT) department indicating that they had a particular issue. For example, a user may send an email indicating that they can't send anymore emails, that they can't print to a particular printer, or cannot connect to a particular backend service such as a collaboration server. Someone in the IT department would look at a list of all requests, determine if each request was appropriate and remediate the issue if appropriate. For example, the IT administrator would look to see if the requesting user can have more disk space, and then adjust the configuration of a mail server to increase the user's quota if the user is authorized to have more disk space. When scaled over thousands of requests, the amount of time is appreciable and there are bound to be errors that require additional time to correct.

There have been attempts to automate the network administration process. Conventional network management systems (NMS) use a combination of hardware and software to monitor and administer a network. Such network management systems allow a user to report issues with a computer or other device using some qualitative description. In response, the NMS downloads temporary but static code to the user's machine, which executes to get common information needed by technicians to aid in analysis of the issue. Such conventional diagnostics are generally limited to basic system parameters, such as determining IP addresses, MAC addresses, and installed applications. Upon receipt of the diagnostic data obtained by the NMS, an IT technician manually remediates the issue. However, conventional approaches do not go far enough or lend themselves well to dealing with human error introduced in the manual remediation of issues and the business cost due to the time spent fixing all issues. Accordingly, there is a continued need for further automation of network administration to reduce network administration labor costs.

### SUMMARY

Embodiments of the present technology are directed toward extensible task execution techniques for computing systems. In one embodiment, a computing system includes a plurality of user computing devices, a plurality of backend devices, services and resources, a portal, a configuration management database, an operation manager and a workflow engine. The portal is adapted to receive stimuli, such as user requests and system incidents. The configuration management database defines the various relationships between entities, such as backend servers, services and/or resources, users and user devices, in the IT environment. The workflow engine includes a plurality of workflow instances. The workflow engine matches a given workflow instance to the stimulus, determines a context based on the stimulus from the configuration management database and provides contextual tasks to the configuration management database based upon the given workflow instance and the determined context. The operation manager initiates one or more contextual tasks on one or more user computing devices, backend devices, backend services and/or backend resources.

In another embodiment, an extensible task execution method includes receiving a stimulus. One or more task sets corresponding to the stimulus are determined from an extensible group of task sets. A context, based on the determined one or more task sets and the stimulus, is determined from a repository of information about an information technology environment. Thereafter, execution of the one or more tasks sets are initiated, using the context, on one or more appropriate entities selected from the group consisting of one or more user computing devices, one or more backend devices, one or more backend services and/or one or more backend resources.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary computing system for implementing embodiment of the present technology.

FIG. 2 shows a block diagram of an extensible task execution method, in accordance with one embodiment of the present technology.

FIG. 3 shows a data level component representation of a configuration management database, in accordance with one embodiment of the present technology.

FIG. 4 shows a dataflow model of the extensible task execution system, in accordance with one embodiment of the present technology.

FIG. 5 shows a flow diagram of an extensible task execution method, in accordance with one embodiment of the present technology.

### DETAILED DESCRIPTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

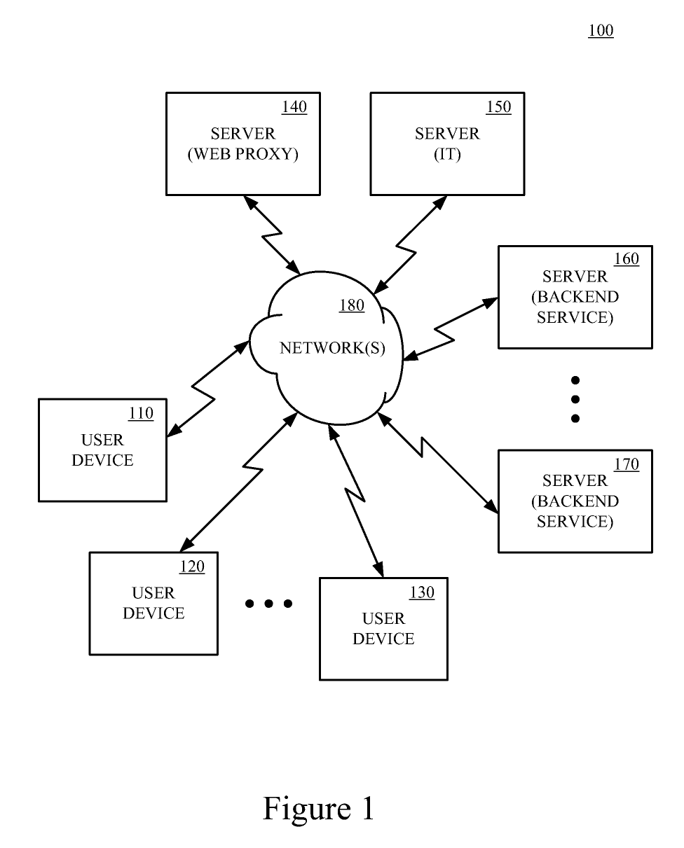

Referring now to FIG. 1, an exemplary computing system for implementing embodiments of the present technology is shown. The computing system 100 includes one or more user devices 110-130 communicatively coupled to one or more servers 140-170 by one or more networks 180. The user devices may be any computing device, such as a desktop computer, laptop computer, smart phone, personal digital assistant (PDA), pager, or the like. Each user device may be associated with one or more users and/or each user may be associated with one or more user devices. For example, a user may be associated with a desktop computer, a smart phone and a laptop. Another user may be associated with another desktop computer. The servers may provide any number of services and/or resources, generally referred to as backend services and resources. One or more of the services may be accessible to one or more users through their respective user devices. Such a computing system is also referred to herein as an Information Technology (IT) environment.

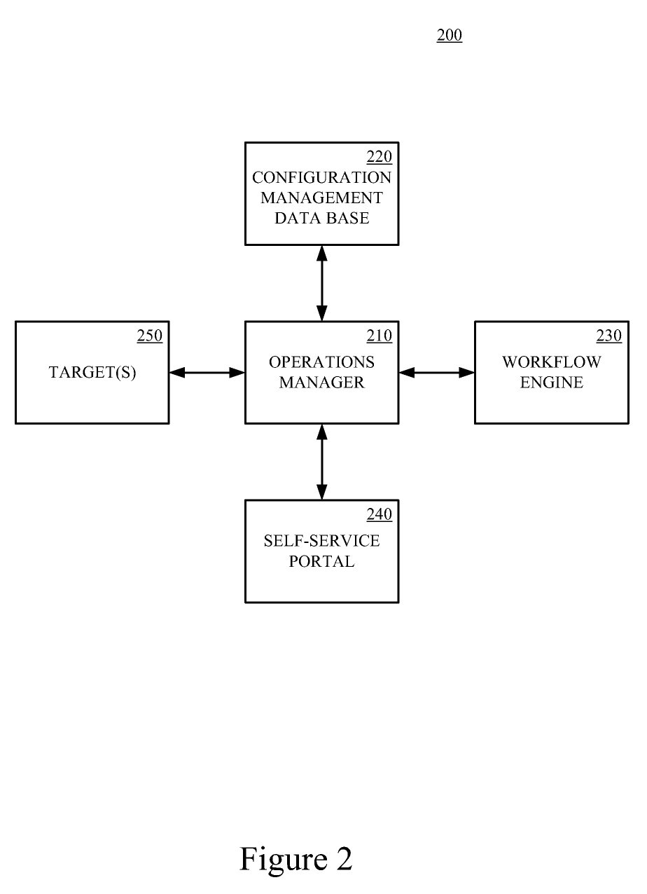

One or more of the servers 140-170 also implement an extensible task execution system. Referring now to FIG. 2, an extensible task execution system, in accordance with one embodiment of the present technology, is shown. The extensible task execution system 200 includes an operations manager 210 communicatively coupled between a Configuration Management Database (CMDB) 220, a workflow engine 230, a portal or the like 240 and a plurality of target devices, services, resources and the like 250 of the IT environment 100. The operations manager 210, CMDB 220, workflow engine 230, and portal 240 may be implemented as computing device readable instructions stored on one or more computing device readable media which when executed by one or more computing devices of an IT environment provide the extensible task execution techniques described herein.

The operations manager 210, CMDB 220, workflow engine 230, and portal 240 of the extensible task execution system 200 may be implemented on a given server or distributed across a plurality of servers in the IT environment 100. For example, in one implementation, the operations manager 210, workflow engine 230, CMDB 220 and portal 240 may be implemented on a single server such as an information technology (IT) department server 150. In another implementation, the operations manager 210, workflow engine 230 and CMDB 220 may be implemented on an IT department server 150, and the portal 240 may be implemented on a web proxy server 140. However, it is appreciated that these components can be separated out and do not need to reside on the same computing device. For example, the CMDB may be one database server, the workflow engine may be another server, the operations manager may be still another server and the portal may be yet another server.

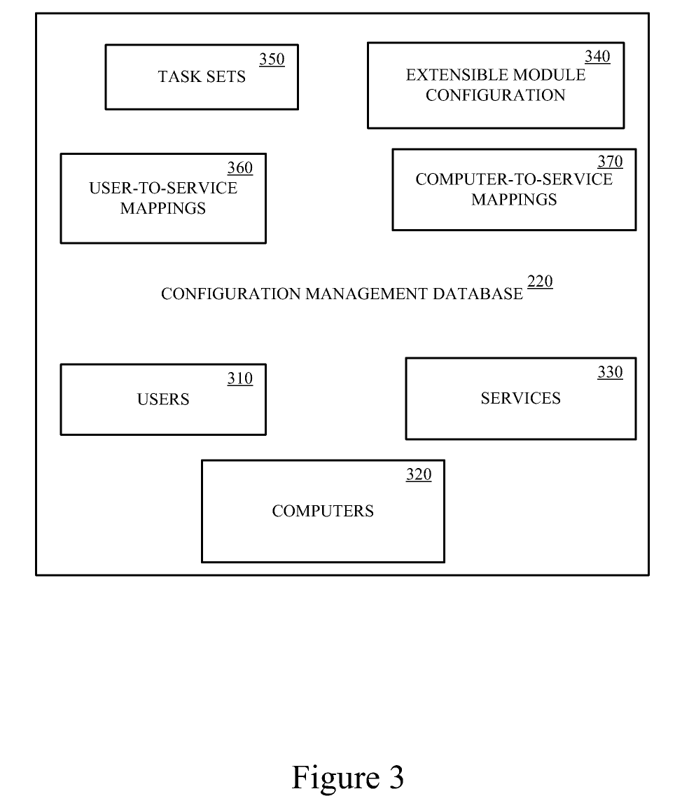

The operations manager 210 monitors the operation of entities in the IT environment and receives user generated requests. The operations manager 210 may also receive health information from each computer identified in the CMDB 220. The operations manager 210 also has the ability to run action on computer it monitors. The operations manager 210 also interacts with, stores information in and retrieves information from the CMDB 220. The workflow engine 230 reads information in from the CMDB 220 and workflow instances based upon a received stimulus. The stimulus may be a user request or system incident determined from monitoring the operation of system entities. The stimulus may also be some form of compliance check, which determine whether or not a system meets a set of criteria of the IT department. For example, the criteria may include verifying whether or not the system has all of the correct files, registry keys, applications installed and/or the like. If the check fails, an incident can be generated which would cause a given task execution. This stimuli, the self-service stimuli, system monitoring stimuli and any other stimulus, as outlined in FIG. 3, are each a manifestation of a plug-in/module that connects with this extensible task system.

The second aspect of the extensible nature of the system are the task sets. Each workflow instance includes one or more task sets that are brought into memory based on the received stimulus. Information read in from the CMDB 220, and that may also be received with the stimulus, provides a context for execution of the workflow instance. The operations manager 210 manages execution of the applicable task sets to remediate issues and/or collect diagnostic data about such issues. The remediation/diagnostic output may also be available for an analyst to review and/or for reporting purposes.

The workflow engine 230 allows the developer and/or administrator to author, define and/or modify workflow instances to service a corresponding stimulus. Different workflow instances can be added that are not hard coded into the workflow engine 230. The workflow instances for remediating complex IT issues or collecting diagnostic data concerning such issues can be developed and distributed with products by developers, or venders, or developed by IT administrators. Thereafter, the workflow instances can be configured and installed into a given IT environment by the vendor, developer or IT administrators.

Referring now to FIG. 3, a data level component representation of a configuration management database (CMDB), in accordance with one embodiment of the present technology, is shown. The CMDB details the interconnected dependencies between users, devices, entities, services and resources. The CMDB 220 includes user 310, computer 320 and service 330 data components. The CMDB 220 also includes extensible module configuration 340, task sets 350, user-to-service mappings 360, and computer-to-service mappings 370 business logic data components.

The extensible module configuration 340 stores request types mapped to workflows. For example, a “cannot send email” would translate into a specific workflow which would diagnose and/or fix the email issue. The task set 350 data component includes a plurality of workflow instances. The workflow instances have the ability to orchestrate execution of applications on computers defined in the CMDB and make decisions based off of the output from the tasks executing. The user-to-service mappings 360 are schematized data that aids the system in understanding which services different users have a relationship to. The user-to-service mappings 360 allow the system to understand which workflow instance (e.g., request types) are available for the user on the self-service portal. Similarly, the computer-to-service mappings 370 are schematized data that aid the system in understanding which services are available on which computing devices. In addition, each task within a task set 350 can either leverage the user's credentials or some stored credentials for executing action on each server in a service using data in the user-to-service mappings 360 and/or computer-to-service mappings 370.

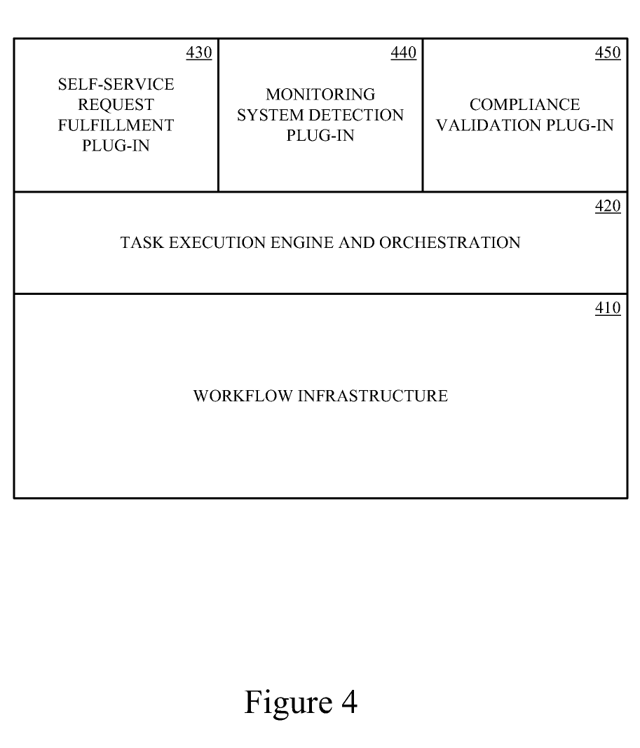

Referring now to FIG. 4, a dataflow model of the extensible task execution system, in accordance with one embodiment of the present technology, is shown. The workflow engine 230 of the extensible task execution system includes a workflow infrastructure 410, and a task execution and orchestration engine 420. The operation manager 210 of the extensible task execution system may include a self-service request fulfillment plug-in 430, a monitoring system detection plug-in 440, and/or a compliance validation plug-in 450. The plug-in aspect of the system may be extended to support new types of stimuli.

Task execution by the operations manager 210 can be initiated from the self-service request fulfillment plug-in 430 to provide contextual request fulfillment. The workflow engine 230 is an extensible infrastructure 410 for initiating tasks by the operations manager 210. User relationships in the CMDB 220 are leveraged by the operations manager 210 to identify applicable context based on the request and one or more corresponding task sets 430 of the workflow engine 230. The tasks are executed by the operations manager 210 on one or more appropriate target entities 250 in the IT environment based on the user's request for service and context determined from the CMDB 220 and optionally the user request.

The compliance validation plug-in 450 provides for receipt of stimulus as a result of some compliance error found in a user's machine and causes a set of tasks to be executed on the user's machine or elsewhere to get the user back in compliance without user interaction. The monitoring system detection plug-in 440 provides the ability to detect and remediate an issue with the user's computer, such as detecting a virus, and automatically orchestrate other services in the IT environment to quarantine the user's computer so that it will not infect other computers. These check may run on a timed basis, and when a deviation from “normal” is detected a stimulus is generated which takes the system through the defined course of action.

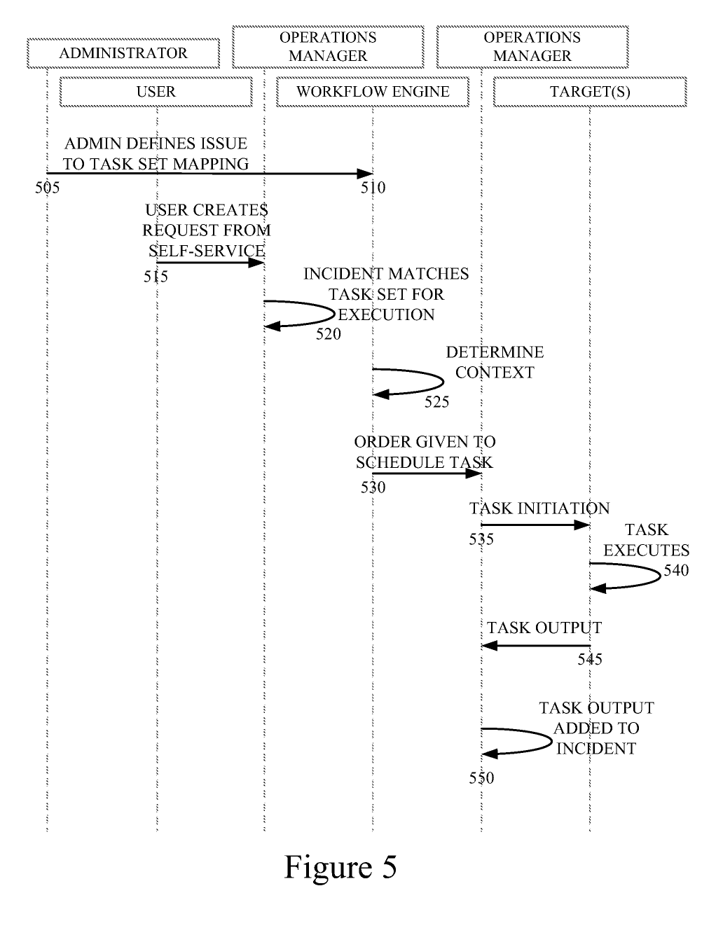

Referring now to FIG. 5, an extensible task execution method, in accordance with one embodiment of the present technology, is shown. The method includes a configuration mode and an operating mode. In the configuration mode, an IT administrator, software developer, hardware vendor or the like define one or more task set mappings, at 505. Task set mappings, applicable to the system 100, are added to the workflow engine 230 as workflow instances, at 510. Each workflow instance may include a task or task set name, a description, a task or set of tasks, the credentials to run the task or tasks under, the parameters that the user is allowed to set, the parameters that are hard coded for the given workflow instance, the urgency of the task or task set execution, the scheduling of execution of tasks, and the like, as well as a reference to the task itself like a script or executable. Each workflow instance also includes a reference to a template model of a generic user to a service set. For example, the user to service set mapping might specify that a generic administrative assistant in a given building has access to the messaging service (which is composed of particular servers), identity service and collaboration service.

In one example, the workflow can specify that if an issue is described as being related to “Office Applications” that an executable called “officediag.exe” should be executed on the user's machine to diagnose the health of the installation and another executable “msiexe” can be called to initiate a repair operation on the office application to make sure all of the configuration files are correct in the installation. All of the output of these operations can be tracked inside the request made by the user.

The framework allows for many workflow definitions/types each associated with a particular kind of stimulus to be defined/configured by developers and/or administrators. Within a workflow instance there may be a plurality of tasks, each of which can by executed to do specified operations on the user's devices and/or backend services.

In the operating mode, a stimulus is received by the operations manager, at 515. The stimulus may be a service request received from a user or a system incident. The service request may be received from the user through a web-enabled self-service portal. The user can make a request either using free-form text or through basic property selection to initiate task execution. For example, a user may fill out a form on a website (e.g., a menu based GUI) that leads the user through a basic set of information to figure out the correct workflow. In particular, a first drop down menu may provide a list containing the name of each available workflow instance. In response to user selection of a given workflow instance from the first drop down menu, one or more additional menus may be presented to collect user specifiable parameters applicable to the selected workflow instance. For Example, if the user has two computers the system may ask the user which computer they are having trouble on, what application they are having trouble with and so on.

At 520, the operations manager consults the workflow engine to match the stimulus to a given workflow instance. If a workflow instance matching the received stimulus is found, a configuration management database (CMDB) may be accessed to determine IT environment parameters applicable to the received stimulus, at 525. The CMDB is a repository of information related to all the components of the IT environment. The CMDB contains details about the important attributes and relationships between configuration items, such as each user's relationship to services that the user has access to and policies that govern what the user can do. The workflow engine through the CMDB is able to determine the user's relationship to each of the user's devices and services, such as the user's laptop, desktop, mobile phone, e-mail server, file shares, web sites, backend resources and the like. In one instance the CMDB is a massive tree that details the interconnected dependencies between users, devices, entities, services and resources.

Once the request is determined to be acceptable, either automatically by some approval policy or by administrator intervention, the workflow instance applicable to the stimulus is executed on the appropriate systems entities to fulfill the request. In particular, the workflow engine sends the context and the task or task set corresponding to the given workflow instance to the operations manager to schedule execution of the contextual task or task set, at 530.

At 535, the operations manager initiates execution of the contextual tasks on one or more targets devices. At 540, the one or more targets execute the contextual tasks. The operations manager can reach out to the user desktop to execute code locally and/or reach out to backend resources and/or services to execute code thereon. The one or more target computing devices may then return a result of the task to the operations manager, at 545. The success or failure of the one or more task sets applicable to the request may be recorded as an incident record in a log in addition to any helpful diagnostic data, at 550.

In one example, if a user is requesting additional disk space for their email inbox the operations manager determines from the CMDB which mail server the user is serviced by (e.g., user to mail system relationship) and can determine whether or not the user is allowed to request more space. Thereafter the process can remotely connect to the mail server and tell it to perform the specific action with the necessary context parameters. Furthermore, if increasing the user's email box quota failed, the system can generate an incident record and route it to the messaging analyst with additional context to help them resolve the issue. Additionally, the system can leverage its knowledge about other things affecting the target system such as pending or completed change requests. If a change request recently occurred on the server or servers in question, and the automated task failed the user or analyst working the incident can be given more context as to why. If the request was completed successfully, by the system dynamically identifying what the user's email server was and calling the right management interfaces on it to make the desired change, the system can be configured to send a message to the user indicating that the request was fulfilled automatically, and potentially provide them with some additional information such as documentation.

The above described system and methods may be utilized to service a “Team Meeting Place” request for example. The “Team Meeting Place” request includes the creation of a collaboration site, creation of one or more discussion lists and storage space on one or more file servers. The process begins with receipt of a request to create a “Team Meeting Place” from a user to the workflow engine through the self-service portal. The workflow engine queries the user through the self-service portal for one or more parameters. The user sets one or more parameters such as the name of the “Team Meeting Place,” the number of users, the identity of the users and their access rights. In response to the complete request including the user specified parameters the workflow engine queries the CMDB to determine one or more IT environment parameters applicable to the request. The workflow engine then constructs a contextual task set based on the workflow instance applicable to the request and the context that includes both user and system parameters. The contextual task set is provided to the operations manager which schedules and controls execution of the task set on one or more target devices. In particular, one or more tasks with appropriate context may be executed on a Collaboration Server to create a Team Site with the specified name. One or more tasks may be executed on an Identity Service (e.g., Active Directory) to create an Active Directory Discussion List with appropriate names. One or more tasks may also be executed on a File Share Service to create new file shares for the Team with appropriate access rights. The success or failure of the task executions on the Collaboration Server, the Identity Service and File Share Service may be returned to the operations manager. If the tasks are successfully completed the operations manager may return a task complete notification with detail status to the workflow engine. The workflow engine may update the CMDB, create a log of the request fulfillment, or the like. In addition, notification of the request fulfillment may be returned to the user through the self-service portal or other messaging means such as email.

Accordingly, embodiments of the present technology advantageously provide extensible task execution techniques for computing systems. Contextual task execution may be provided on one or more user devices and/or on one or more backend computing devices, services and/or resources. The contextual task execution may be used to automatically remediate and/or gather diagnostic data concerning system issues in response to user requests and/or system incidents.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the Claims appended hereto and their equivalents.

What is claimed is:

1. A computing system comprising:
a plurality of user computing devices;
a plurality of backend devices, services and resources;
a configuration management database for various relationships between the plurality of user computing device, the plurality of backend devices, services and resources;
a portal for receiving a stimulus;
a workflow engine, including a plurality of workflow instances, for matching a given workflow instance to the stimulus, determining a context for the stimulus from the configuration management database and generating a contextual task based upon the given workflow instance and the context; and
an operations manager for initiating the contextual task on a given user computing device, a given backend device, a given backend service or a given backend resource.

2. The computing system of claim 1, wherein the portal comprises a self-service web-enabled portal.

3. The computing system of claim 1, wherein the workflow engine comprises a workflow infrastructure and a task execution and orchestration engine.

4. The computing system of claim 1, wherein the operations manager comprises a self-service request fulfillment plug-in.

5. The computing system of claim 1, wherein the operations manager comprises a monitoring system detection plug-in.

6. The computing system of claim 1, wherein the operations manager comprises a compliance validation plug-in.

7. A method comprising:
receiving a stimulus;
determining one or more task sets corresponding to the stimulus from an extensible group of task sets;
determining a context based on the determined one or more task sets and the stimulus from a repository of information about an information technology environment;
initiating execution of the one or more tasks sets using the context on one or more appropriate entities of the information technology environment.

8. The method according to claim 7, wherein initiating execution of the one or more task sets using the context comprises remediating one or more issues on the one or more appropriate entities.

9. The method according to claim 7, wherein initiating execution of the one or more task sets using the context comprises collecting diagnostic data on the one or more appropriate entities.

10. The method according to claim 7, wherein receiving a stimulus comprises receiving a user request and one or more user specified parameters.

11. The method according to claim 7, wherein receiving a stimulus comprises receiving a system incident and one or more system specified parameters.

12. The method according to claim 7, wherein one or more of the task sets are defined and added to the group by one or more of an information technology administrator, a developer, and a vendor.

13. The method according to claim 7, wherein one or more of the task sets are configured by an information technology administrator.

14. One or more computing device readable media including instructions which when executed cause a computing system to implement an extensible task execution method comprising:
receiving a stimulus;
matching the stimulus to a given workflow instance;
determining parameters applicable to the received stimulus and the given workflow instance; and
executing one or more tasks on one or more target devices specified by the given workflow instance and the parameters.

15. The one or more computing device readable media according to claim 14, further comprising receiving a result of executing the one or more tasks.

16. The one or more computing device readable media according to claim 15, further comprising updating the CMDB based on the results.

17. The one or more computing device readable media according to claim 15, further comprising saving the results as diagnostic data.

18. The one or more computing device readable media according to claim 15, further comprising saving information concerning the stimulus, the given workflow instance, the parameters, the one or more tasks, the one or more target devices and the results in a data log.

19. The one or more computing device readable media according to claim 14, wherein the stimulus comprises a request from a user.

20. The one or more computing device readable media according to claim 19, further comprising reporting the results to the user.
